(19) United States
(12) Patent Application Publication
(10) Pub. No.: US 2014/0298150 A1
(43) Pub. Date: Oct. 2, 2014

(54) SYSTEMS AND METHODS FOR MANAGING FEATURES AND ATTRIBUTES IN A DIGITAL DOCUMENT

(71) Applicant: Adapx, Inc., Seattle, WA (US)

(72) Inventors: Michael Robin, Redmond, WA (US); Phil Cohen, Bainbridge Island, WA (US)

(21) Appl. No.: 14/299,966

(22) Filed: Jun. 9, 2014

Related U.S. Application Data
(63) Continuation of application No. 13/206,479, filed on Aug. 9, 2011, now abandoned.

(51) Int. Cl. G06F 17/22; G06F 3/0481; G06F 3/033; G06F 17/24

(52) U.S. Cl. CPC G06F 17/2235; G06F 17/246; G06F 3/04817; G06F 3/033
USPC 715/205

(57) ABSTRACT

In many environments such as municipal, military and construction the use of digital and paper systems permits end users to create or modify features on digital document, attributes associated with those features, or attribute values associated with those features. The attribute value management system includes a digital pen, at least one digital document, one or more computing devices, and a number of software programs for creating data relationships between the digital documents (e.g., features on maps and their underlying attribute values), interpreting voice or handwritten data, validating the interpreted data, and uploading the validated data to a geo-database. The attribute value management system functions to create, update or otherwise change the attribute values associated with the features by a temporal association method; a linked identification method; or a direct handwriting method.

### PRIORITY CLAIM

This application claims priority to and the benefit U.S. patent application Ser. No. 13/206,479, filed on Aug. 9, 2011, and which claims priority to and the benefit of U.S. Provisional Application Nos. 61/371,991 and 61/427,971, filed Aug. 9, 2010 and Dec. 29, 2010, respectively, and wherein the subject matter of the aforementioned applications are incorporated by reference herein in their entireties.

### BACKGROUND

A geographical information system (“GIS”) is an information system that provides the ability to create, save, interact with, analyze, and display geospatial data. In contrast, a map display system merely has the ability to present geo-registered maps/imagery. For example, a GEOPDF® document by TERRAGO® offers the ability to display maps as PDFs, and to record the geo-coordinates of a cursor, enabling “red line” markups, positioning of geo-registered icons as “stamps”, displaying a GPS trail, etc. The GIS is database driven—the visualization involves the rendering of properties of the data, both their geospatial extent as well as other attribute-values. Thus, a street in a map system is merely a set of colored geo-referenced pixels or lines, whereas for a GIS, it has attributes and values such as street names, thickness (useful data for a concrete company), etc. The “geodatabase” in a GIS is typically a relational database, with tables representing types of objects, specific objects represented as rows, and columns that represent attributes of those objects. Typically, one of the columns provides spatial data (e.g., latitude-longitude, addresses, etc.) so that the object can be located on the Earth. The objects themselves may have complex shapes (point, line, or poly-line). In some GISs, the objects on a map user-interface (UI) are segregated into various “layers,” often based on object type, which the GIS user can turn on/off. The user interface to the GIS system will typically offer many different icons that control GIS functions, including the display of objects, and the invocation of analytical tools (e.g., shortest path algorithms, indivisibility calculations, terrain reasoning, etc). Typically, there will be a ‘legend’ on the GIS display, and rendered on the map, which associates symbols with the objects via a set of labels. The term “GIS” is herein used to include those GIS systems manufactured by Environmental Systems Research Institute, GOOGLE® (e.g., GOOGLE® map and Earth GIS systems), MICROSOFT® (VIRTUAL EARTH® GIS system), IBM® (Smart Planet GIS system), MAPQUEST® GIS system, PITNEY BOWES® (MAPINFO® GIS system), and many others. The term “GIS” may also include computer-aided design (CAD) systems, such as those manufactured by AUTODESK®, BENTLEY®, ARCHICAD®, etc., and building-information management systems, such as those manufactured by AUTODESK® and BENTLEY®, and others. It also includes icon display and positioning systems, such as those manufactured by MICROSOFT® VISIO®, that include attribute-value data associated with those icons.

Further, the GIS stores and displays spatial information, accepts inputs into a geographic database (“geo-database”) underlying that geospatial display, and supports calculations based on the geographic information to support decision-making

Unfortunately, the complexity of GIS software and end-user computer equipment has made it difficult for field workers, untrained in the intricacies of GIS, to collect needed data. Adapx, Inc. has addressed this need by developing digital paper and pen mapping software based on ANOTO® technology that integrates with leading GIS software from Environmental Systems Research Institute called ARCGIS® software and from TERRAGO® called GEOPDF® software. This technology enables untrained users to provide GIS data by marking on digital paper maps using digital pens. Such data is immediately geo-registered by the software and made available for subsequent processing.

Because data collection is via paper and pen, a broad class of end users already knows how to use the device. For example, sixth-grade students have used the technology during Earth Day events in Nashua, N.H. to indicate on digital paper maps the location of garbage in their city that needed to be picked up. When the data was imported into the city's GIS system, GPS-equipped garbage trucks could then be routed to the specified locations.

Although map markup has many uses, many GIS workflows involve the users providing attribute-value data for newly created or existing map features. For example, in the past, the US Census Bureau often incorporated an “address canvassing” step in the decennial census, in which a census worker would mark the position of a new housing structure on a map, write a “map spot” label and then on a subsequent page would enter that map spot label into a table and provide various attributes about the related housing structure. For example, the worker could indicate that it had four bedrooms, two stories, was unoccupied, etc. Unlike the automated process described here, a census office worker then needed to update the geo-database by hand. Many industries that capture geospatial information have very similar attribute-value data collection needs.

### SUMMARY

In many environments such as municipal, military and construction the use of digital and paper systems permits end users to create or modify features on digital document, attributes associated with those features, or attribute values associated with those features. The attribute value management system includes a digital pen, at least one digital document, one or more computing devices, and a number of software programs for creating data relationships between the digital documents (e.g., features on maps and their underlying attribute values), interpreting voice or handwritten data, validating the interpreted data, and uploading the validated data to a geo-database. The attribute value management system functions to create, update or otherwise change the attribute values associated with the features by a temporal association method; a linked identification method; or a direct handwriting method.

In one embodiment, a method for managing attributes associated with features using a digital pen and digital document system includes the steps of (1) with the digital pen, generating a feature on a digital document using feature icon located in a legend visible on the digital document, wherein during a time period of less than or equal to about ten seconds the digital pen sequentially contacts the feature icon and then contacts a different portion of the digital document to generate the feature; (2) further sequentially in time and within about less than or equal to ten seconds from generating the feature, modally associating an attribute with the feature, wherein the attribute operates to modify the feature, and wherein modally associating the attribute with the feature includes linking the attribute to a digital paper spreadsheet using a linking icon in the legend on the digital document; (3) interpreting the attribute; and (4) validating the interpreted attribute.

In yet another embodiment, a method for managing attributes associated with features in a digital paper document includes the steps of (1) with a digital pen, touching an action icon on the digital paper document and then handwriting a linking identifier proximate to the feature; (2) handwriting the linking identifier into a data input region of a digital paper spreadsheet; (3) handwriting an attribute value into another data input region of the digital paper spreadsheet, the attribute value associated with the feature; (4) interpreting the linking identifier and the attribute value; and (5) validating the interpreted linking identifier and the interpreted attribute value.

In still yet another embodiment, a method for managing attributes associated with features in a digital document includes the steps of (1) with a digital pen, establishing a relationship between an action icon on the digital document and a feature on the digital document by touching the action feature and then contemporaneously touching the feature with the digital pen; (2) entering an attribute value of the feature onto a surface of the digital document; (3) interpreting the handwriting; and (4) uploading the interpreted attribute values into a document database.

### BRIEF DESCRIPTION OF THE DRAWINGS

FIG. 1 is a digital map having features and a legend in accordance with an embodiment of the present invention;

FIG. 2 is an attribute value table associated with the digital map of FIG. 1 in accordance with an embodiment of the present invention;

FIG. 3 is an attribute value table with pre-processed, handwritten values in accordance with an embodiment of the present invention;

FIG. 4 is an attribute value table with post-processed values converted from the handwritten values of FIG. 3 in accordance with an embodiment of the present invention;

FIG. 5 is a digital map having features, a legend and handwritten attribute value information placed directly onto a surface of the digital map in accordance with an embodiment of the present invention;

FIG. 6 is close up view of the legend of FIG. 5; and

FIG. 7 is a system diagram of a computing system operable with a digital pen in accordance with an embodiment of the present invention.

### DETAILED DESCRIPTION

The need for collecting data via field workers untrained in the intricacies of GIS involves the use of digital pen and paper technology; one or more software applications that allows an end user to develop their own forms, maps, etc. by integrating digital pen and paper technology with other software applications; one or more methods for attribute creation, collection, revision, and fusion; and one or more methods for attribute validation (e.g., error checking) This enables the use of existing paper-based work practices, which minimizes training, while providing a digital output that can lead to substantial productivity gains.

Digital pen and paper technology provides a dot pattern that is printed on a paper document and a digital pen that senses that pattern. Unlike relative-positioning digital pens, these digital pens read not only an absolute position on a page; the pens know precisely what page it is. The pen records the coordinates of the pen on the page, as well as certain meta-data (e.g., the page's unique identifier, date, time, etc.). The X-Y data is stored in the pen until it is unloaded or transmitted to another system. Application software then interprets the digital ink markings in the context of the specific piece of paper they were written on. One of the more common types of digital pen/paper technology is made by Anoto, A B. The pen may have simultaneous voice capture, such as one manufactured by LIVESCRIBE™. Voice may also be captured by a time-synchronized voice recording device, including but not limited to a cellphone, tablet, personal computer (PC), dictation recorder, etc.

Various types of software applications may be utilized to integrate the digital pen and paper technology into commercially viable offerings. In some instances, the software application enables the end user to fill out forms, though the design of the form is usually done by the software vendor. One of these software applications is developed and sold by Adapx, Inc. The software application, referred to as CAPTURX® software, enables the end user to develop their own forms, maps, etc. by integrating digital pen and paper technology with software applications such as, but not limited to, ARGIS® software made by Environmental Systems Research Institute; and ONENOTE®, EXCEL® or SHAREPOINT® software made by MICROSOFT® Corporation.

Many users who wish to collect GIS-related data in the field find that existing mobile computer systems can be too small, too complex, too expensive, and/or too fragile to be used effectively by their mobile work force. Typically, their field data has been collected via paper and pen, and then rekeyed by the GIS department or even by the end user into an enterprise database.

CAPTURX® for ARCGIS® software enables an end user to create “feature-class” data in the field, such as to position a new feature (e.g., a manhole) on the map, without having to manipulate the underlying application or know anything about the GIS. CAPTURX® software is a plug-in to the ARCGIS® software, and thus operates transparently with it. With the plug-in, the end user is able to print a digital paper version of a map or other document, along with a legend, which then becomes a user interface. The user may add feature-class instances of the elements in the paper's legend by ticking them with the digital pen, and then drawing their geospatial extent. Taken together, the digital document, digital pen, pen docking station, computing devices and the various software packages are referred to herein as an attribute management system.

In one embodiment, the digital document may take the form of a map for firefighting. The map would include a legend having a plurality of elements or symbols that may appear on the map, along with the map itself. The symbols may be, but are not limited to, point, line, and area-based elements. The user may locate firefighting information (e.g., proposed bulldozer lines, aerial foam drops, escape routes, etc.) by touching selected elements in the legend and drawing them on the map. Once the digital pen is docked, or the data is sent remotely via a wireless connection to a computing device or personal digital assistant (PDA) running the GIS software, then the geo-database updates are incorporated and made available digitally for validation.

The creation of features on the map is just one part of the field GIS workflow. End users typically also need to enter or update the attributes of those features. By way of example, within the ARCGIS® software, each feature has corresponding attributes and/or values stored in a set of database tables. To update the attributes, values or both the end user needs to provide tabular input in addition to geospatial input. However, the ARCGIS® software, as well as other similar GIS systems, does not provide an easy-to-use interface for tabular input suitable for field personnel.

Creating, updating or otherwise changing the attributes-values may be accomplished using a number of methods, which are described below with reference to their potential commercial viability, ease of use for the end user (e.g., time to train and time to create or update an attribute), and validation error rate (specifically: procedural, recognition and fill-in error rates), validation efficiency (e.g., time to validate), number of requests for help, geospatial error, and lastly user preference.

The systems and methods for creating, updating or otherwise changing the attribute-values are as follows: (1) a temporal association method; (2) a linked identification method; and (3) a direct on-map method. Each of these systems and methods will be explained in detail below.

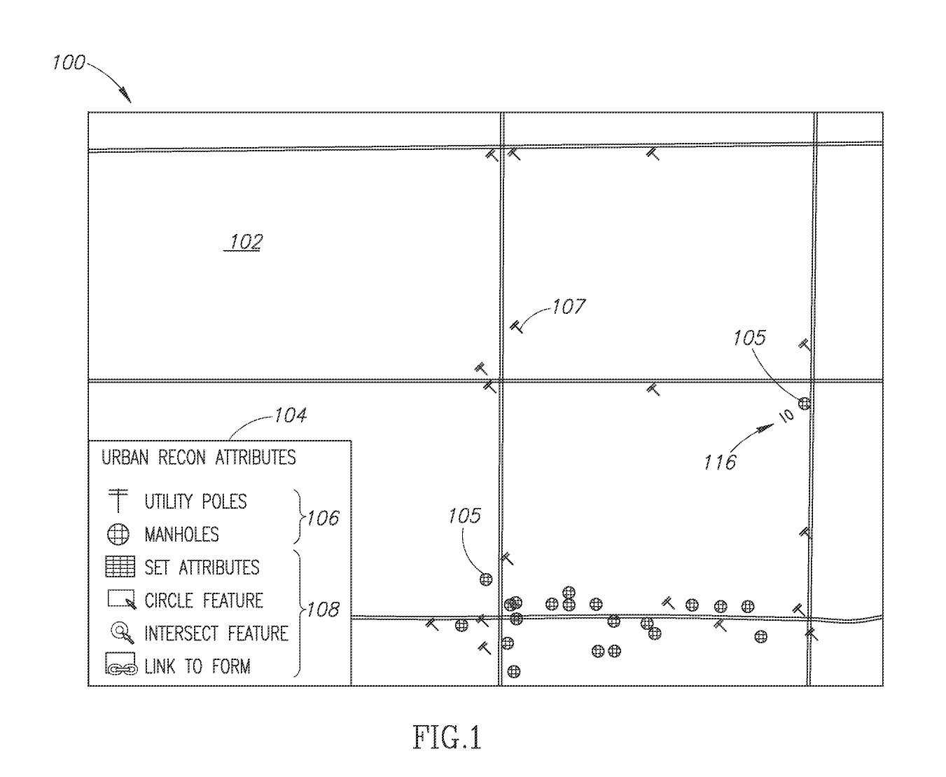

In one embodiment of the temporal association method, a digital pen and paper system allows a user to set arbitrary attributes on both newly-created and existing features. FIG. 1 shows a digital paper map 100 having a map portion 102 and a legend 104 having map features 106, wherein each of the map features 106 may have one or more attributes. The user interacts with an action palette layer 108 that has been added to the digital paper map 100. To add a new feature 106, the user, such as an inspector, ticks that feature 106 on the legend 104, such as manhole 105 or utility pole 107, and marks on the map 102 where that feature 106 should be placed with one-stroke. The one-stroke may take the form of a circle, a line, a square, a checkmark or some other mark that may be made without lifting the digital pen from the paper. At the point, the feature 106 has been associated with a location on the map 102. By way of example, to update an existing feature's attribute value, the user ticks the circle feature icon with the digital pen, which invokes that function on the subsequent ink stroke. This function allows the user to circle a point feature that already exists on the map. Once that feature has been selected, the user would employ the set attribute icon to provide the relevant attribute-value data on the map. If the user wishes to supply attribute-value data for a linear or area feature, the user ticks the intersect feature icon and then draws a line or tick mark on the map crossing the line representing the linear or area feature.

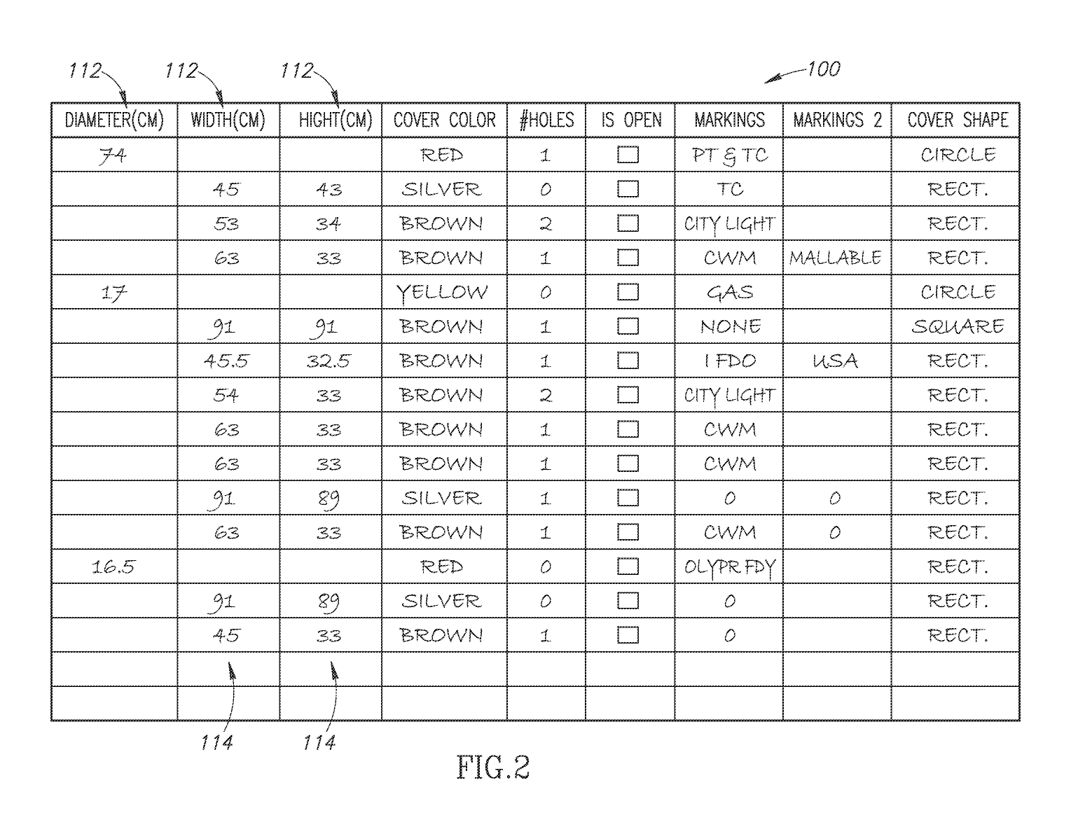

Once the one-stroke has been completed and now referring to FIG. 2, the user goes directly to filling in a digital chart or spreadsheet 110 with the attributes 112 for the feature that was just selected. In the illustrated embodiment, the attributes 112 take the form of the column headings such as “Diameter,” “Width,” “Height,” etc.; each row represents one of the manholes 105 on the map 102 (FIG. 1); and the data at any particular column-row intersection provides an attribute-value 114 for an attribute 112 of one of the manholes 105. The digital pen records the time for each event, meaning the time for making the one-stroke on the map 102 and the time for entering the attribute data 112 on the chart 110. A temporal association is determined between these two events such that the time stamp on the map 102 and the time stamp on the chart 110 will determine what attribute data belongs in which row. In one embodiment, the temporal association assigns each manhole 105 a row on the chart 110.

In one embodiment, the user may associate a particular attribute with a corresponding value by selecting the set attribute icon 106 in the legend 104 and then initiating a multimodal input, such as handwriting or voice while making the one-stroke on the map 102. The phrases may be abbreviated (e.g., “Diam@36” or “Col@yellow”) for handwriting, or spoken (“diameter is thirty six”. The “@” character may take the form of other types of separator characters such as, but not limited to “=” or “:”. The invention generates a handwriting grammar/regular-expression used by the handwriting recognition engine that corresponds to the allowable attribute names and their values, which allows flexible matching of user input which can vary from user to user. A similar grammar is generated for use of the voice recognition software. This process generates both a “word list” grammar containing an unordered list of possible words the user may write or say, and a regular grammar that (a) accepts any prefix of an attribute name (such as “col” for “color”), (b) accepts user-specified synonymous forms (such as “grey” and “gray”), (c) accepts the proper data type (such as a number or a date) and (d) accepts only allowable values for any attribute that has fixed domain of values (such as “large” or “small” for the attribute “size”.) The invention then does a “fuzzy” match between what the recognizer returns from both the word-list and regular grammars and the expected attributes and values, and picks the most likely match the act upon. Upon docking the pen, a processing system uses a handwriting and/or voice recognition program and possibly natural language understanding or various heuristics to interpret the written ink and to handle abbreviations (for handwriting), and to convert spoken attribute-values to text. A database stores all of the attributes and values from the chart 110 and an object or row identifier may be generated. At this time, the user may see the chart 110 displayed on a screen and make any corrections, if needed. Multiple handwritten attribute-values may be specified at once by using a pattern-directed match, where one or more the patterns is specified by a grammar or regular-expression designed by the user with the help of the invention and where the attribute names are implicit in the pattern. For example, writing “35in/round/brown” rather than “Size@35in”, “Shape@round” and “Color@brown”. A “leader line” from the attribute location to the written attribute text may also be drawn by the user to aid in association of these two items.

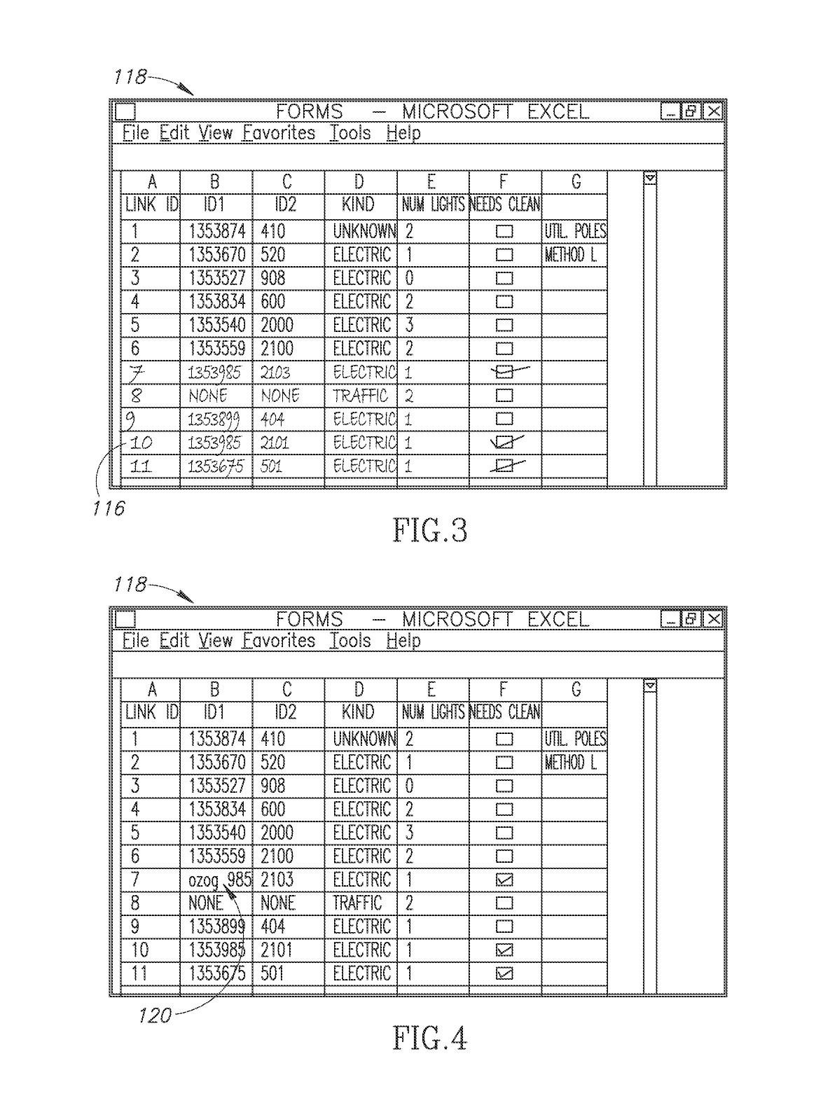

In one embodiment, the linked identification method takes advantage of the ARCGIS® capability for combining external data relations with relations in the geo-database. And, CAPTURX® for Microsoft Excel enables users to fill out charts or spreadsheets with digital pen and paper, including storing the time of captured ink stokes used in the embodiment of the timing method. To provide the needed attribute-value update capability, an attribute table from ARCGIS® is exported in a form that is readable by the chart or spreadsheet, with an automatic population of data types and handwriting and voice grammars from the table to the chart or spreadsheet. The attribute table is also provided with metadata that will inform ARCGIS® about the data types when the data is returned. Then, using the CAPTURX® for Microsoft Excel software a user can print such a form digitally, fill it out with a digital pen in the field, and when the pen is docked import the data back into the chart or spreadsheet. From there, the handwriting recognition can be validated and the information from the chart or spreadsheet imported to the geo-database to be coordinated with the map or other digital document. Since there may be more than one set of attributes and values for any given feature, the attribute-value update method needs to enable the user to indicate which feature goes with which attribute-value data. The linked identification method enables the user to associate a particular feature with a plurality of values through a linking identifier handwritten on the map and then the same linking identifier is entered into a LINK ID column in the chart or spreadsheet (FIGS. 3 and 4).

Referring back to FIG. 1 and also referring to FIGS. 3 and 4, the user writes an identifier 116 on the map 102, and as illustrated the identifier 116 is the number “10,” which could indicate the tenth manhole 105 inspected by the user. After writing the identifier 116 on the map 102, the user writes the same identifier 116 in a digital paper attribute chart 118. Now, the user may add or modify one or more of the attribute values associated with the tenth manhole and each value will be associated with the identifier 116.

FIG. 4 shows the attribute chart 118 after the handwriting has been processed, meaning the handwriting has been converted to text. An interpretation error 120 may be readily identified by the user and corrected at this time. Once corrected, the data from the chart 118 may be uploaded to the geo-database such that the next time the map 102 is printed then at least some of the attribute values for at least some of the features will have changed.

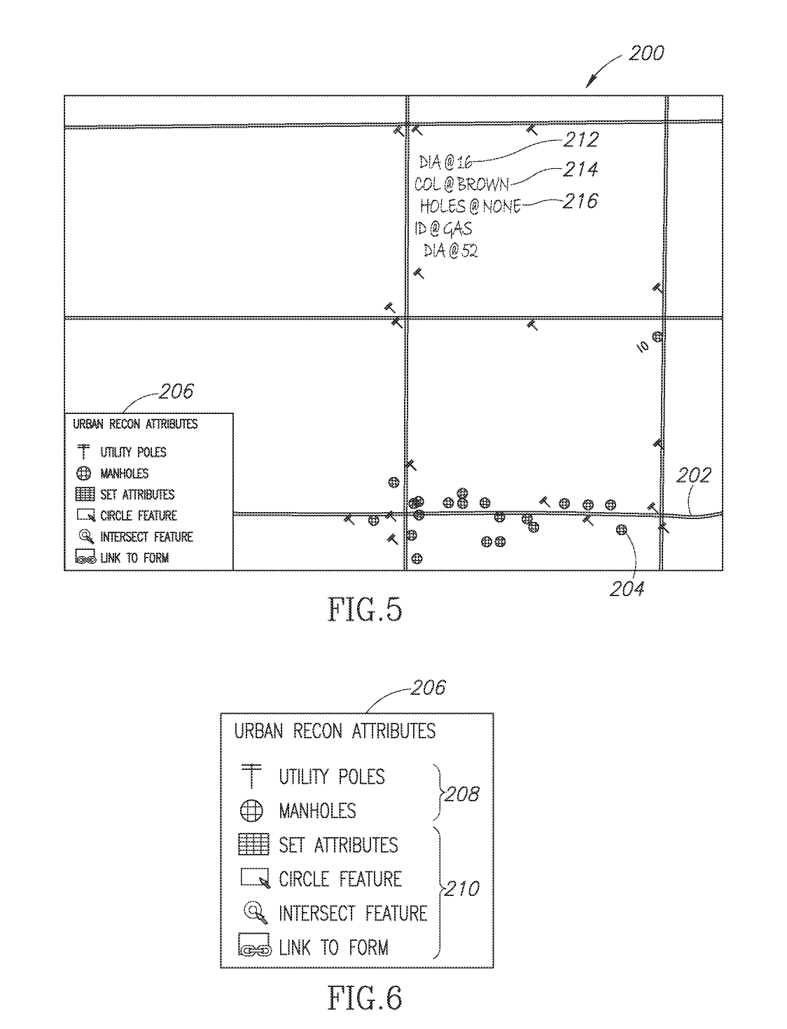

FIG. 5 shows a digital paper document 200, which takes the form of a map that includes a road feature 202, a plurality of manhole features 204 and a legend 206. Further, FIG. 5 shows a map attribute update “session”, in which the user may be adding or changing one or more of the features displayed on the map by writing the attribute-value data directly onto the digital map 200, or speaking the attributes and values. For purposes of clarity, a larger version of the legend 206 is shown in FIG. 6. The legend includes a plurality of feature icons 208 and action icons 210.

Referring to FIG. 5, the direct handwriting method for creating, updating or otherwise changing the attributes and/or attribute values associated with the features 204, 206 permits the user to directly write on the map 200. In the illustrated example, the user comes across a manhole that does not appear on the map 200. To create the manhole 204 the user ticks the manhole feature icon 208 in the legend 206 and then ticks or draws on the map 200 at the proper location to create the manhole feature 204. Next, the user ticks the set attribute action icon 210 on the legend 206, and handwrites text 212 (e.g., Dia@16) anywhere on the map 200. Next, the user again ticks the set attribute action icon 210 and writes another text 214 (e.g., Col@brown) anywhere on the digital map 200. Alternatively, the user may speak “color brown”. Later, upon coming across an existing manhole that needs attention, the user ticks either the circle feature or the intersect feature action icon 210. The user may then circle or apply an ink marking onto the existing manhole feature to generate the necessary relationship. With the existing manhole now associated with the user's actions, the user ticks the set attribute action icon 210 and handwrites text 216 (e.g., holes@none) anywhere on the map 200.

When the digital pen is docked, the handwriting and/or voice will be recognized and the user will be able to see from a display of the digital map on the computer that a feature has been created, and by inspecting the attribute table, will be able to see that the new feature has the correct values for each attribute and that the existing feature now indicates the manhole cover has missing holes.

Example embodiments described herein provide applications, tools, data structures and other support to implement the various methods for creating or revising attribute values associated with one or more features on a map or other digital document. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the techniques and/or functions described are not limited by the particular order, selection, or decomposition of steps described with reference to any particular routine.

The attribute management system communicates with one or more computing systems for practicing embodiments of the attribute management system. By way of example, one or more general purpose or special purpose computing systems/devices may be used. In addition, the computing system may comprise one or more distinct computing systems/devices and may span distributed locations. Furthermore, the described methods may be implemented in software, hardware, firmware, or in some combination to achieve the capabilities described herein.

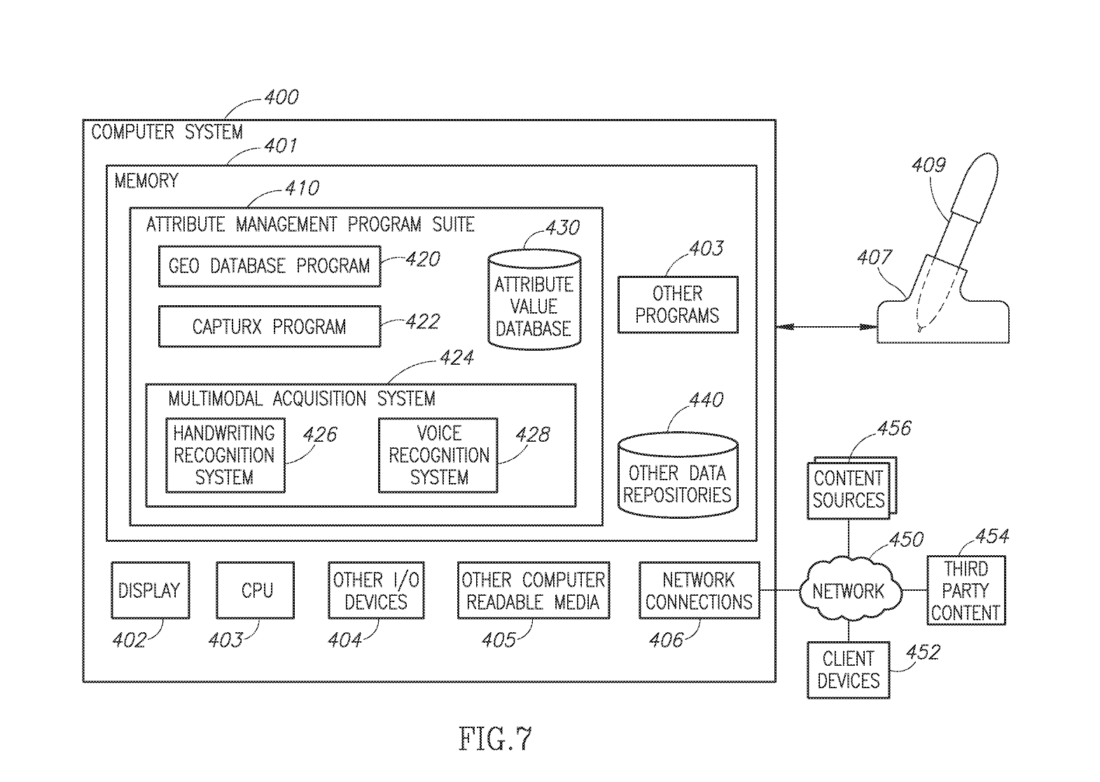

FIG. 7 shows a computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406. A digital pen docking station 407 with a digital pen 409 may be in communication with the computing system 400. The programs for performing the methods described above may reside in the memory 401. In other embodiments, some portion of the contents, some or all of the components of the attribute management system may be stored on and/or transmitted over the other computer-readable media 405. The programs in the memory preferably execute on one or more CPUs 403 and extract and provide quotations, as described herein. Other code or programs 430 (e.g., an administrative interface, a Web server, and the like) and potentially other data repositories, such as data repository 440, also reside in the memory 401, and preferably execute on one or more CPUs 403. Of note, one or more of the components in FIG. 4 may not be present in any specific implementation. For example, some embodiments may not provide other computer readable media 405 or a display 402. By way of example, the speech may be recorded with microphones or some other sound recordation device and then processed with a speech recognizer. The microphone may be located in the digital pen or in another device that is capable to store sound in a time-synchronized manner in conjunction with another computing device, such as a receiving computer. Similarly, the handwriting and/or sketching may be perceived with an ink-sensitive surface and then processed by a sketch or handwriting recognizer.

In a typical embodiment, as described above, the Attribute Management Program Suite 410 includes Geo-database Program 420, such as the ARCGIS® software described above, and the CAPTURX® for Microsoft Excel Program 422. The Attribute Management Program Suite 410 performs methods such as those described above. The Multimodal Acquisition System 424 includes a Handwriting Recognition System 426 and a Voice Recognition System 428 for interpreting the handwritten data or voice data, respectively.

The Attribute Management Program Suite 410 may interact via the network 450 with (1) content sources 456, (2) with third-party content 454 and/or (3) client devices/multimodal input sources 452. The network 450 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The client devices 452 include desktop computing systems, notebook computers, mobile phones, smart phones, digital pens, personal digital assistants, and the like.

In an example embodiment, components/modules of the Attribute Management Program Suite 410 are implemented using standard programming techniques. For example, the Attribute Management Program Suite 410 may be implemented as a “native” executable running on the CPU 403, along with one or more static or dynamic libraries. In other embodiments, the Attribute Management Program Suite 410 may be implemented as instructions processed by a virtual machine that executes as one of the other programs 403. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, MODULA®, and the like), scripting (e.g., PERL®, Ruby, PYTHON®, JAVASCRIPT®, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the Attribute Management Program Suite 410 can be made available by standard mechanisms such as through C, C++, C#, and Java APIs; libraries for accessing files, databases, or other data repositories; through languages such as XML; or through Web servers, FTP servers, or other types of servers providing access to stored data. An additional database 424 may be implemented as one or more database systems, file systems, or any other techniques for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of Attribute Management Program Suite 410 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of this disclosure. Portions of the various methods and systems described herein may be combined to achieve attribute and value management relative to a digital document. For example, the methods, techniques, and systems for content recommendation are applicable to other architectures. Also, the methods, techniques, and systems discussed herein are applicable to differing query languages, protocols, communication media (optical, wireless, cable, etc.) and devices (such as wireless handsets, electronic organizers, personal digital assistants, portable email machines, game machines, pagers, navigation devices such as GPS receivers, digital pens, etc.).

The embodiments of the invention in which an exclusive property or privilege is claimed are defined as follows:

1. A method for managing attributes associated with features using a digital pen and digital document system, the method comprising:
with the digital pen, generating a feature on a digital document using feature icon located in a legend visible on the digital document, wherein during a time period of less than or equal to about ten seconds the digital pen sequentially contacts the feature icon and then contacts a different portion of the digital document to generate the feature;
further sequentially in time and within about less than or equal to ten seconds from generating the feature, modally associating an attribute with the feature, wherein the attribute operates to modify the feature, and wherein modally associating the attribute with the feature includes linking the attribute to a digital paper spreadsheet using a linking icon in the legend on the digital document;
interpreting the attribute; and
validating the interpreted attribute.

2. The method of claim 1 wherein sequentially contacting the feature icon and the different portion of the digital document includes contacting the feature icon and then contacting the different portion of the digital document with a writing tip of the digital pen.

3. The method of claim 1 wherein modally associating the attribute with the feature includes handwriting a value associated with attribute into the digital paper spreadsheet.

4. The method of claim 1 wherein modally associating the attribute with the feature includes speaking a value associated with attribute while generating an ink stroke with the digital pen into a cell of the digital paper spreadsheet.

5. The method of claim 1 wherein modally associating the attribute includes handwriting at least the attribute directly onto the digital document in proximity to the feature.

6. The method of claim 1 wherein linking the attribute to the digital paper spreadsheet, and after contacting the linking icon, includes entering a linking identifier proximate the feature on the digital document.

7. A method for managing attributes associated with features in a digital paper document, the method comprising:
with a digital pen, touching an action icon on the digital paper document and then handwriting a linking identifier proximate to the feature;
handwriting the linking identifier into a data input region of a digital paper spreadsheet;
handwriting an attribute value into another data input region of the digital paper spreadsheet, the attribute value associated with the feature;
interpreting the linking identifier and the attribute value; and
validating the interpreted linking identifier and the interpreted attribute value.

8. The method of claim 7 further comprising storing time stamps for the touching and handwriting activities.

9. The method of claim 7 wherein handwriting the linking identifier includes handwriting an alphanumeric character.

10. The method of claim 7 wherein interpreting the linking identifier and the attribute value includes processing the handwriting with a handwriting recognition program.

11. The method of claim 7 wherein interpreting the linking identifier and the attribute value includes processing the voice recording with a voice recognition program.

12. The method of claim 7 wherein handwriting the linking identifier into the data input region of the spreadsheet includes handwriting the linking identifier into an input cell of the spreadsheet.

13. The method of claim 7 wherein validating the interpreted linking identifier and the interpreted attribute value includes visually reading the interpreted linking identifier and the interpreted attribute value on a display screen.

14. A method for managing attributes associated with features in a digital document, the method comprising:
with a digital pen, establishing a relationship between an action icon on the digital document and a feature on the digital document by touching the action feature and then contemporaneously touching the feature with the digital pen;
entering an attribute value of the feature onto a surface of the digital document;
interpreting the handwriting; and
uploading the interpreted attribute values into a document database.

15. The method of claim 13 wherein entering the attribute value includes speaking the attribute value which is recognized as text by a voice recognition program.

16. The method of claim 13 wherein entering the attribute value includes handwriting the attribute value which is recognized as text by a handwriting recognition program.

17. The method of claim 13 further comprising validating the uploaded attribute values against the input handwriting or voice data.
